(19) United States
(12) Patent Application Publication
(10) Pub. No.: US 2015/0013647 A1
(43) Pub. Date: Jan. 15, 2015

(54) Method for Operating a Fuel Injection System with Fuel Injection Valve Regulation to Increase the Quantitative Accuracy, and a Fuel Injection System

(71) Applicants: Hong Zhang, Tegernheim (DE); Detlev Schöppe, Wenzenbach (DE)

(72) Inventors: Hong Zhang, Tegernheim (DE); Detlev Schöppe, Wenzenbach (DE)

(21) Appl. No.: 14/382,092

(22) PCT Filed: Mar. 18, 2013
(86) PCT No.: PCT/EP2013/055523

§ 371 Date: Aug. 29, 2014

(30) Foreign Application Priority Data
Mar. 19, 2012 (DE) 10 2012 204 272.5

(51) Int. Cl. F02M 51/06

(52) U.S. Cl. CPC F02M 51/0603
USPC 123/478

(57) ABSTRACT

A method for operating a fuel injection system of an internal combustion engine uses a piezo actuator that includes, in addition to the active piezo region used to actuate the servo valve, a passive piezo region that acts as a force sensor. A force measurement is performed using this force sensor during the injection phase or in the injection pause, and a correction variable for controlling the piezo actuator is determined from the deviation between the actual force progression and a target progression, in order to regulate the injection process in this manner. A fuel injection system configured to perform such a method is also disclosed.

### CROSS-REFERENCE TO RELATED APPLICATIONS

This application is a U.S. National Stage Application of International Application No. PCT/EP2013/055523 filed Mar. 18, 2013, which designates the United States of America, and claims priority to DE Application No. 10 2012 204 272.5 filed Mar. 19, 2012, the contents of which are hereby incorporated by reference in their entirety.

### TECHNICAL FIELD

The present invention relates to a method for operating a fuel injection system of an internal combustion engine, the fuel injection system having a pressure accumulator (rail), at least one injection valve in which a piezo actuator actuates a servo valve, which is arranged in a servo valve chamber, counter to the force of a closing spring such that a closure element opens an injection opening that is connected via a fuel line to the pressure accumulator, and a control and regulation unit.

### BACKGROUND

Fuel injection systems used for performing the injection of fuel into a combustion chamber of an internal combustion engine have long been known. Such injection systems comprise at least one injection valve (injector) and at least one control and regulation unit, connected to the injection valve, for controlling the injection process. Here, the injection valve has a chamber from which fuel can be injected into the combustion chamber through an injection opening. The opening and closing of the injection opening is performed by means of a closure element (nozzle needle) which can be actuated (moved) by an actuator. The chamber is supplied with fuel via a high-pressure accumulator and a fuel line.

The actuator is an element for moving the closure element. It is thus the case that an injection process is controlled by means of the actuator. Here, the actuator does not have a direct drive connection to the closure element, but instead actuates a servo valve in order to discharge highly pressurized fuel from a servo valve chamber and thereby effect an actuation of the closure element and open the associated injection opening.

The actuator is a piezo actuator which, based on the piezoelectric effect, expands (increases in length) when charged with electrical energy and thereby lifts the servo valve from its seat in order thereby to actuate the closure element.

To regulate the injection process, it is the case in the injection systems of the prior art with piezo servo drive that the closing time of the closure element is determined and regulated. This assumes that the idle travel of the piezo actuator is known. Therefore, at the same time, the idle travel is adapted (by means of a pressure drop or by means of a frequencyamplitude change of the piezo actuator during the activation). This adaptation method is however relatively slow, and accuracy and robustness are dependent on the design of the injection valve. Depending on operating conditions, a situation may arise in which the quantity tolerance is large.

### SUMMARY

One embodiment provides a method for operating a fuel injection system of an internal combustion engine, the fuel injection system having a pressure accumulator (rail), at least one injection valve in which a piezo actuator actuates a servo valve, which is arranged in a servo valve chamber, counter to the force of a closing spring such that a closure element opens an injection opening that is connected via a fuel line to the pressure accumulator, and a control and regulation unit, wherein the piezo actuator used has a passive piezo region as a force sensor in addition to the active piezo region used to actuate the servo valve; wherein the force acting on the passive piezo region when the servo valve is opened is determined by means of said force sensor; and wherein the force determined by the force sensor is compared with a setpoint value dependent on the pressure in the pressure accumulator (rail pressure), and the corresponding deviation is used for correcting the activation of the piezo actuator.

In a further embodiment, during the injection phase, the profile of the force signal from the charging to the discharging of the piezo actuator is compared with the setpoint profile in a manner dependent on the pressure in the pressure accumulator (rail pressure) and the deviation is used for correcting the activation of the piezo actuator.

In a further embodiment, during the injection phase, the opening time andor closing time of the servo valve are detected by way of the force measurement and compared with the corresponding setpoint times, and in that the deviation is used for correcting the activation of the piezo actuator.

In a further embodiment, during the injection interval, the active piezo region is activated with a slow current profile and the force is measured by means of the force sensor, wherein the force signal maximum corresponding to the opening time of the servo valve is determined and compared with the setpoint value in a manner dependent on the pressure in the pressure accumulator, and the deviation is used for correcting the activation of the piezo actuator for the injection at the respective pressure accumulator pressure.

In a further embodiment, during the injection phase, the force sensor is used to measure a force signal maximum, corresponding to the reversal time of the closure element, and a force signal minimum, corresponding to the closing time of the closure element, and the ACTUAL injection time is determined from the difference between the two times and is compared with the SETPOINT injection time, wherein the deviation is used for correcting the activation of the piezo actuator.

In a further embodiment, during the recharging of the actuator, the charge is set such that the force on the force sensor remains below the closing force of the servo valve.

In a further embodiment, the closing force of the servo valve is calculated as follows:

F_schliess=A_{—}st*Pv+F_fed,

where
F_schliess=closing force of the servo valve,
A_st=area of the servo valve seat,
P_v=servo valve chamber pressure, and
F_fed=servo valve spring force.

Another embodiment provides a fuel injection system for an internal combustion engine, the fuel injection system having a pressure accumulator (rail), at least one injection valve in which a piezo actuator actuates a servo valve, which is arranged in a servo valve chamber, counter to the force of a closing spring such that a closure element opens an injection opening that is connected via a fuel line to the pressure accumulator, and a control and regulation unit, wherein it is set up for performing any of the methods disclosed above.

In a further embodiment, the passive piezo region is formed by an additional, serially arranged, passive piezo layer.

### BRIEF DESCRIPTION OF THE DRAWINGS

Example embodiments of the invention are explained in detail below with reference to the drawings, in which:

FIG. 1 shows a schematic longitudinal section through an injection valve, with an enlarged illustration of the circled region;

FIG. 2 shows a schematic partial longitudinal section through a piezo actuator with force sensor;

FIG. 3 shows the principle of an embodiment for injection regulation;

FIG. 4 shows a diagram showing the profile of the force measured by the force sensor and of the control chamber pressure; and

FIG. 5 shows a flow diagram of an embodiment of the regulating method.

### DETAILED DESCRIPTION

Embodiments of the present invention are based on the aim, in the case of a fuel injection system with piezo servo drive, of precisely regulating both the profile of the servo valve movement and also the profile of the movement of the closure element (nozzle needle) in order to increase the quantitative dosing accuracy. The invention is based on the object of providing a method of the type mentioned in the introduction with which particularly accurate and fast injection regulation can be performed in a simple and robust manner.

Some embodiments of the invention provide a method in which the piezo actuator used has a passive piezo region as a force sensor in addition to the active piezo region used to actuate the servo valve; the force acting on the passive piezo region when the servo valve is opened is determined by means of said force sensor; and the force determined by the force sensor is compared with a setpoint value dependent on the pressure in the pressure accumulator (rail pressure), and the corresponding deviation is used for correcting the activation of the piezo actuator.

In the disclosed method, a piezo actuator is used which additionally has a force sensor by means of which the force exerted on the force sensor is measured. The corresponding signal of the force sensor is then used for the injection regulation. Here, the measured force is compared with a setpoint value, and the corresponding regulation of the injection process is performed by correcting the activation of the piezo actuator.

The disclosed method has multiple embodiments. In a first embodiment, regulation of the servo valve takes place during the injection phase. Here, during the injection phase, the profile of the force signal from the charging to the discharging of the piezo actuator is compared with the setpoint profile in a manner dependent on the pressure in the pressure accumulator (rail pressure) and the deviation is used for correcting the activation of the piezo actuator. In detail, it is the case here that, to realize the injection, the piezo actuator (active region) is activated with a current profile. At the same time, the force measurement is performed by means of the force sensor, it being possible for the electrical voltage of the sensor, and from this, for example by way of a characteristic curve, the force F s exerted on the sensor, to be determined.

In particular, during the injection phase, the opening time andor closing time of the servo valve are detected by way of the force measurement and compared with the corresponding setpoint times. The corresponding deviation is used for correcting the activation of the piezo actuator.

In a further embodiment of the method, regulation of the servo valve is performed during the injection interval. Here, during the injection interval, the active piezo region is activated with a slow current profile and the force is measured by means of the force sensor, wherein the force signal maximum F s max corresponding to the opening time of the servo valve is determined and compared with the setpoint value in a manner dependent on the pressure in the pressure accumulator. The deviation is used for correcting the activation of the piezo actuator for the injection at the respective rail pressure.

If the piezo actuator is activated with a corresponding current profile, the force signal initially increases until a maximum is reached. The force signal subsequently falls again. When the force signal falls, the piezo actuator is discharged again with a negative current profile.

In yet another embodiment of the method, during the injection phase, the force sensor is used to measure a force signal maximum, corresponding to the reversal time of the closure element, and a force signal minimum, corresponding to the closing time of the closure element. The ACTUAL injection time is determined from the difference between the two times and is compared with the SETPOINT injection time. The deviation is used for correcting the activation of the piezo actuator.

The servo valve closing time can be detected by means of the force sensor. The recharging of the piezo actuator takes place only after the closing time. Here, the charge is set such that the force on the force sensor remains below the closing force of the servo valve. The closing force F schliess of the servo valve is calculated as follows:

F_schliess=A_{—}st*P_{—}v+F_fed,

where
F_schliess=closing force of the servo valve
A_st=area of the servo valve seat
P_v=servo valve chamber pressure
F_fed=servo valve spring force

It can thus be ensured that a force connection is reliably present and the servo valve remains closed. By means of the force signal at the sensor, it is possible to monitor the servo valve chamber pressure andor control chamber pressure for the closure element. A maximum in the force signal occurs at the reversal point of the movement of the closure element. Said time is identified as nozzle needle reversal time t nad umk. A minimum in the force signal profile occurs at the time at which the nozzle needle closes. Said time is identified as closing time t nad sch.

The above-described embodiments of the method according to the invention may be used simultaneously with one another or separately from one another. Any desired combinations of multiple methods may be used.

Embodiments of the disclosed method may ensure that, for the same injection quantity demand, the time from the opening to the closing of the closure element can, by means of the regulation that is performed, be maintained in an injector-specific manner and over the service life of the injection valve.

Other embodiments of the invention provide a fuel injection system for an internal combustion engine, the fuel injection system having a pressure accumulator (rail), at least one injection valve in which a piezo actuator actuates a servo valve, which is arranged in a servo valve chamber, counter to the force of a closing spring such that a closure element opens an injection opening that is connected via a fuel line to the pressure accumulator, and a control and regulation unit. According to the invention, said fuel injection system is wherein it is set up for carrying out a method as described above.

The passive piezo region that acts as force sensor is in particular formed by an additional, serially arranged, passive piezo layer.

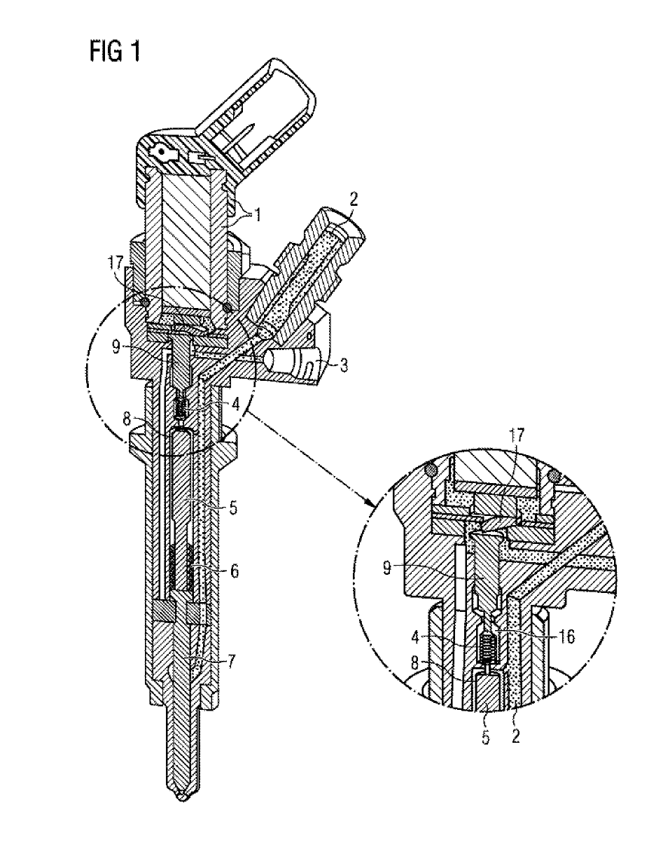

FIG. 1 schematically shows an injection valve which is used for example in a diesel engine of a passenger motor vehicle. Said injection valve serves for injecting fuel into a combustion chamber of an internal combustion engine. Said injection valve has a chamber which is connected via a fuel line (high-pressure line) 2 to a pressure accumulator (high-pressure accumulator) (rail). The injection valve illustrated here is one of a multiplicity of injection valves which, in a common-rail system, are each connected via fuel lines to the same pressure accumulator. At the lower end of the injection valve, said injection valve has an injection opening through which fuel can be injected from the chamber into the combustion chamber. In the chamber there is arranged a nozzle needle 7 which serves as a closure element and by means of which the injection opening can be opened and closed. When the nozzle needle 7 is situated in an open position, in which it opens up the injection opening, highly pressurized fuel is injected from the chamber into the combustion chamber. When the nozzle needle 7 is in a closed position, in which the nozzle needle closes the injection opening, the injection of fuel into the combustion chamber is stopped.

The nozzle needle 7 is controlled by means of a piezo actuator 1. In a manner dependent on an activation, the piezo actuator 1 can vary its length and, via an intensification lever 17, exert a force on a control piston 9, which control piston makes contact with a servo valve 4 which is pressed by way of a closing spring against a valve seat. The servo valve 4 is arranged in a valve chamber 16 which is connected by means of a throttle to a control chamber 8 for the closure element. The control chamber 8 accommodates a piston 5 which actuates the nozzle needle 7.

When the piezo actuator 1 has electrical energy applied to it (is charged), it increases in length and, in this way, causes the control piston 9 to lift the servo valve 4 from its seat, such that the pressure prevailing in the servo valve chamber 16 is dissipated. Owing to this dissipation of pressure, the needle piston 5 and the nozzle needle 7 move upward in the figure, and in so doing, open up the injection opening in order for an injection process to be performed.

FIG. 1 also shows a fuel return line 3 and a closing spring 6 for the nozzle needle 7.

The piezo actuator 1, which is illustrated merely schematically in FIG. 1, has not only the active piezo region 12, which is used for the actuation of the nozzle needle 7, but also a passive piezo region 13 as a force sensor. The force acting on the piezo actuator via the control piston 9 and the intensification lever 17 is determined by means of said force sensor.

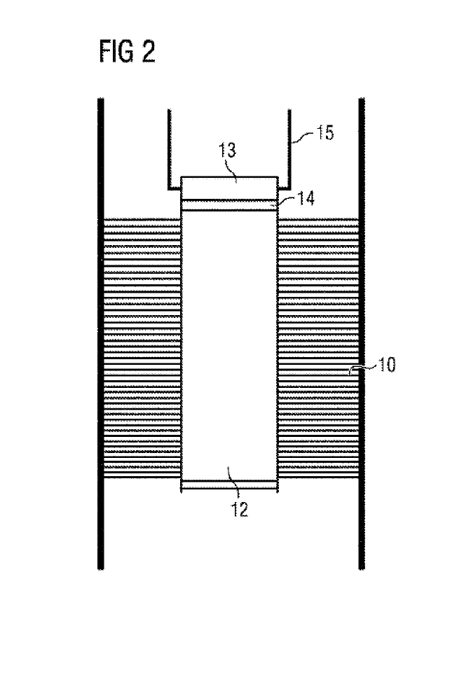

FIG. 2 schematically shows the construction of the piezo actuator 1, which forms a structural unit which has the active piezo region 12, for actuating the nozzle needle 7, and the passive piezo region 13, which serves as force sensor. The active piezo region 12 is made up of a multiplicity of active piezo layers arranged one on top of the other, said piezo layers each having a corresponding connection electrode 10 on the left and on the right. On the uppermost active piezo layer, separated by suitable insulation 14, there is arranged a passive piezo layer which forms the piezo region 13 that acts as force sensor. On both sides, the passive piezo layer is provided with corresponding connection electrodes 15.

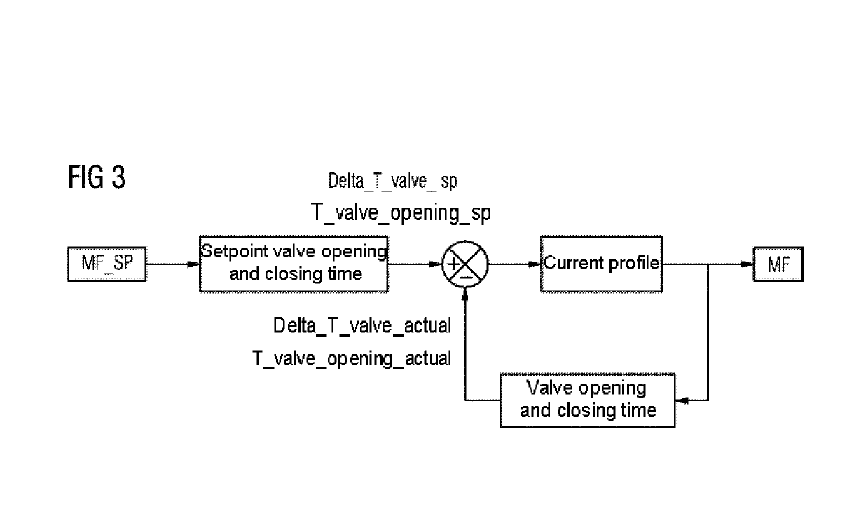

FIG. 3 shows, in a block diagram, the principle of an embodiment of the injection regulation. Here, during the injection phase, the opening time and the closing time of the servo valve are detected by means of the force sensor and are compared with corresponding setpoint times in a manner dependent on the rail pressure. The corresponding deviation is used for regulating the current profile during the activation of the piezo actuator, and thus for regulating the injection process.

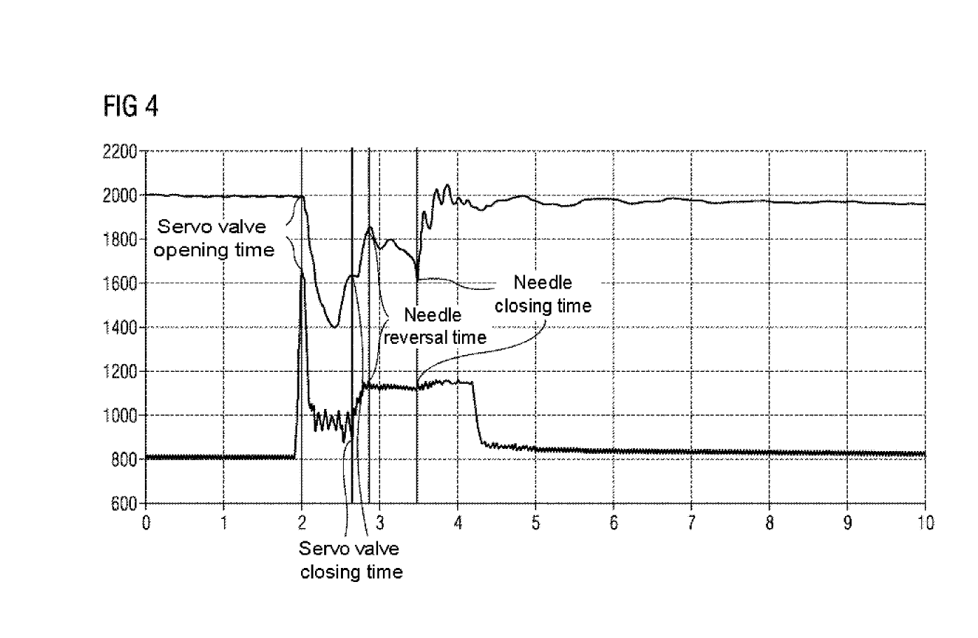

FIG. 4 shows, in a diagram, the profile of the force signal measured by the force sensor (lower curve) and the profile of the pressure in the control chamber for the nozzle needle (upper curve). The corresponding servo valve opening and closing times and needle reversal and needle closing times are indicated. Said points can be detected from the curve profiles and compared with corresponding setpoint values, as explained above. The corresponding deviations can be used for injection regulation.

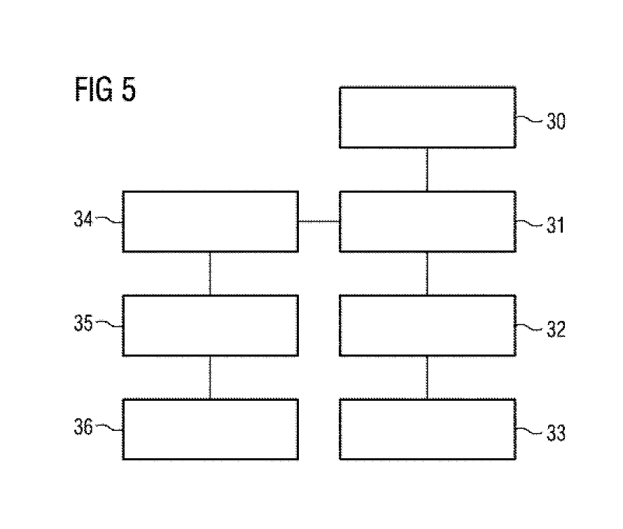

FIG. 5 shows a flow diagram for a variant of the regulating method. In step 30, the piezo actuator (active piezo region) is activated with a current profile. In step 31, the sensor voltage is determined by means of the force sensor that is provided, and the associated force is determined by means of a characteristic curve. In step 32, the profile of the force signal is compared with a setpoint profile, and in step 33, the corresponding deviation is used for correcting the charging profile during the activation of the piezo actuator, and thus for regulating the injection process.

Proceeding from step 31, it is also possible, by means of the determined force profile, to detect the opening andor closing time of the servo valve, as indicated in step 34. The determined times can be compared with corresponding setpoint times (step 35), and the deviations can likewise be used for correcting the charging profile of the piezo actuator (step 36) and thus for regulating the injection process.

What is claimed is:

1. A method for operating a fuel injection system of an internal combustion engine having a pressure accumulator, at least one injection valve in which a piezo actuator actuates a servo valve, which is arranged in a servo valve chamber, counter to a force of a closing spring such that a closure element opens an injection opening connected to the pressure accumulator via a fuel line, and a control and regulation unit, wherein the piezo actuator includes an active piezo region used to actuate the servo valve and a passive piezo region used as a force sensor, the method comprising:
using the passive piezo region of the piezo actuator as a force sensor to determine a force acting on the passive piezo region when the servo valve is opened; and
calculating a deviation between the force determined by the force sensor and a setpoint value dependent on a pressure in the pressure accumulator, and
correcting an activation of the piezo actuator based on the calculated deviation.

2. The method of claim 1, comprising:
during the injection phase, calculating a profile deviation. between a profile of a force signal from a charging of the piezo actuator to a discharging of the piezo actuator with a setpoint profile in a manner dependent on the pressure in the pressure accumulator, and
correcting the activation of the piezo actuator based on the calculated profile deviation.

3. The method of claim 1, comprising:
during the injection phase, detecting at least one of an opening time and a closing time of the servo valve based on the force measured by the passive piezo region of the piezo actuator,
calculating at least one time deviation between at least one of the opening time and the closing time and a respective corresponding setpoint time, and
correcting the activation of the piezo actuator based on the at least one calculated time deviation.

4. The method of claim 1, comprising:
during the injection interval, activating the active piezo region with a slow current profile, and
measurjng a corresponding force signal using the force sensor,
determining a maximum of the force signal corresponding to an opening time of the servo valve and calculating a deviation between the force signal maximum and a corresponding setpoint value in a manner dependent on a particular pressure in the pressure accumulator, and
using the deviation to correct the activation of the piezo actuator for an injection at the particular pressure accumulator pressure.

5. The method of claim 1, comprising:
during the injection phase, using the force sensor to measure a force signal maximum corresponding to a reversal time of the closure element, and a force signal minimum corresponding to a closing time of the closure element,
calculating an actual injection time based on the measured force signal maximum and force signal minimum,
calculating an injection time deviation between the actual injection time and a setpoint injection time, and
correcting the activation of the piezo actuator based on the calculated injection time deviation.

6. The method of claim 5, comprising, during the recharging of the actuator, setting the charge set such that the force on the force sensor remains below the closing force of the servo valve.

7. The method of claim 1, comprising calculating a closing force of the servo valve based on the equation:
F_schliess=A_{—}st*P_{—}v+F_fed,
where
F_schliess=a closing force of the servo valve,
A_st=an area of the servo valve seat,
P_v=a servo valve chamber pressure, and
F_fed=a servo valve spring force.

8. A fuel injection system for an internal combustion engine, comprising:
a pressure accumulator,
at least one injection valve in which a piezo actuator actuates a servo valve, which is arranged in a servo valve chamber, counter to a force of a closing spring such that a closure element opens an injection opening connected to the pressure accumulator via a fuel line,
wherein the piezo actuator includes an active piezo region usable to actuate the servo valve and a passive piezo region usable as a force sensor to determine a force acting on the passive piezo region. when the servo valve is opened; and
a control and regulation unit wherein programmed to:
calculate a deviation between the force determined by the force sensor and a setpoint value dependent on a pressure in the pressure accumulator, and
correct an activation of the iezo actuator based on the calculated deviation.

9. The fuel injection system of claim 8, wherein the passive piezo region is formed by an additional, serially arranged, passive piezo layer.

10. The fuel injection system of claim 8, wherein the control and regulation unit is programmed to:
during the injection phase, calculate a profile deviation between a profile of a force signal from a charging of the piezo actuator to a discharging of the piezo actuator with a setpoint profile in a manner dependent on the pressure in the pressure accumulator, and
correct the activation of the piezo actuator based on the calculated profile deviation.

11. The fuel injection system of claim 8, wherein the control and regulation unit is programmed to:
during the injection phase, detect at least one of an opening time and a closing time of the servo valve based on the force measured by the passive piezo region of the piezo actuator,
calculate at least one time deviation between at least one of the opening time and the closing time and a respective corresponding setpoint time, and
correcte the activation of the piezo actuator based on the at least one calculated time deviation.

12. The fuel injection system of claim 8, wherein the control and regulation unit is programmed to:
during the injection interval, activate the active piezo region with a slow current profile, and
receive a corresponding force signal measured by the force sensor,
determine a maximum of the force signal corresponding to an opening time of the servo valve and calculate a deviation between the force signal maximum and a corresponding setpoint value in a manner dependent on a particular pressure in the pressure accumulator, and
use the deviation to correct the activation of the piezo actuator for an injection at the particular pressure accumulator pressure.

13. The fuel injection system of claim 8, wherein:
the force sensor is configured to measure, during the injection phase, a force signal maximum corresponding to a reversal time of the closure element, and a force signal minimum corresponding to a closing time of the closure element; and
the control and regulation unit is programmed to:
calculate an actual injection time based on the measured force signal maximum and force signal minimum,
calculate an injection time deviation between the actual injection time and a setpoint injection time, and
correct the activation of the piezo actuator based on the calculated injection time deviation.

14. The fuel injection system of claim 13, the control and regulation unit is programmed to, during the recharging of the actuator, set the charge set such that the force on the force sensor remains below the closing force of the servo valve.

15. The fuel injection system of claim 8, the control and regulation unit is programmed to calculate a closing force of the servo valve based on the equation:
F_schliess=A_{—}st*P_{—}v+F_fed,
where
F_schliess=a closing force of the servo valve,
A_st=an area of the servo valve seat,
P_v=a servo valve chamber pressure, and
F_fed=a servo valve spring force.
